(19) United States
(12) Patent Application Publication
(10) Pub. No.: US 2008/0019003 A1
(43) Pub. Date: Jan. 24, 2008

(54) Vacuum Roll Coated Security Thin Film Interference Products With Overt And/Or Covert Patterned Layers

(75) Inventors: Roger W. Phillips, Santa Rosa, CA (US); Vladimir P. Raksha, Santa Rosa, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, Milpitas, CA (US)

(21) Appl. No.: 11/861,352

(22) Filed: Sep. 26, 2007

Related U.S. Application Data
(63) Continuation-in-part of application No. 11/766,305, filed on Jun. 21, 2007.
Application No. 11/766,305 is a continuation-in-part of application No. 10/891,335, filed on Jul. 14, 2004, now abandoned.
(60) Provisional application No. 60/487,527, filed on Jul. 14, 2003.

(51) Int. Cl. G02B 5/28

(52) U.S. Cl. 359/582

(57) ABSTRACT

A semitransparent OV device is formed using a partially transparent reflective layer having a thickness below the opaque point. For example, a partially transparent aluminum layer having a thickness of less than 20 nm, coated with a dielectric layer and an absorber layer, provides a color shifting optical stack that is partially transparent, so that an image or text printed on the substrate under the optical stack or on the opposite side of the substrate, is visible therethrough. In one embodiment, the substrate is light transmissive so that the OV foil is semitransparent so that information printed on paper and covered with such a foil may be read through this foil.

### CROSS-REFERENCE TO RELATED APPLICATION

The present application is a continuation-in-part of U.S. patent application Ser. No. 11/766,305 filed Jun. 21, 2007, which is a continuation-in-part of U.S. patent application Ser. No. 10/891,335 filed Jul. 14, 2004, which claims priority from U.S. Provisional Application No. 60/487,527, filed Jul. 14, 2003, by Phillips et al., entitled: “Imaged Optical Foils”, the disclosures of which are incorporated herein by reference for all purposes.

### BACKGROUND OF THE INVENTION

The use of security threads for protecting banknotes, credit cards and other valuable documents is well known. A security thread is a strip of material placed on the surface of a banknote document or sheet such as banknote; alternatively a security thread may be serpentined or woven into the banknote paper (a window type effect) to confer additional security (authenticity) to the bank note. Typical dimensions of a hot stamp thread are a width of 1-5 mm, a thickness of 3-4 μm; windowed polyester terephthalate (PET) based threads have a thickness of about 0.5 mil or 12.5 microns. By way of example, one of the earliest forms of security threads consisted of reflective foil transferred by hot stamping to the surface the banknote (GB 2119312 A). This reflective foil prevented reproduction of counterfeit banknotes by printing processes such as from printing presses, PC printers and copiers. Holograms (EP-A-0624688), holographic features along with thermo chromic features (GB 2347646), opaque coatings having characters and patterns readable by transmitted light in combination with luminescent substances (U.S. Pat. No. 6,474,695), repeating patterns of magnetic/magnetic indicia or metal dots (W02103624), laser etching fine lines and text with a laser (German “Auslegeschrift” no. 22 05 428) and (WO02101147), printing micro-characters on a metalized transparent plastic with clear acid resistant inks followed by acid etching of the unprinted areas to produce shiny micro-characters on a transparent base (U.S. Pat. No. 4,652,015), bonded nucleic acid molecules so that complementary nucleic acid molecules can bind to the molecules already attached to the document (DE 10122836), and optically variable security elements using liquid crystal material (EP0435029) have all been used to make security threads. However, these aforementioned threads either take too much time to make and or have other associated problems; for example, it is found that laser etching takes too long to be cost effective, etching by use of chemicals requires multiple steps and is not considered to be environmentally-friendly; holograms can be readily copied, and in many instances the features of the threads are not readily seen by eye by the average person and machines are required to read them.

For all intents and purposes, all references described heretofore or hereafter are incorporated herein by reference.

A method to pattern a single layer of metal or carbon in a vacuum chamber was advanced in U.S. Pat. No. 4,022,928 by Piwcyzk. Piwcyzk used various methods to apply a perfluoropolyether known as FOMBLIN™ or Krytox™ to a substrate requiring a pattern for a vacuum deposited layer. The perfluoropolyether inhibited the deposition of the depositing material to a web or plastic substrate. Application of this fluid was by spray or vacuum evaporation in combination with a selected removal process as with a laser or an electron beam. A printing method was also described. Printing techniques including relief printing such as letterpress or flexography, planographic printing such as offset lithography, and gravure, and screen-printing such as silkscreen process printing were disclosed.

Subsequently, Ronchi in U.S. Pat. No. 4,749,591 incorporated herein by reference, and in PCT application WO 8700208(A1)) advanced this printing process by applying the inhibiting oil, FOMBLIN, to a vacuum roll coater where patterning thin films on plastic substrates was desired.

Ronchi in U.S. Pat. No. 4,749,591 only discloses applying a single layer of metal, for example, aluminum as is shown in FIG. 1, deposited as a vacuum thin film layer. A demetallized aluminum layer in the case of a security thread embedded into a banknote can easily be forged by simply using a metallized polyester that is subsequently patterned by one of the above methods. In an attempt to copy a security thread having a single layer manufactured by Ronchi's technique, patterning by photolithography in combination with a caustic etchant, or by any of the aforementioned processes or even by using a silver pencil to simulate the security thread could be used.

Multi-layer security devices are disclosed in U.S. Pat. No. 6,686,027 in the name of Caporaletti et al. and U.S. Pat. No. 7,054,042 in the name of Holmes et al., referred to hereinafter as '027 and '042, respectively.

In '027 Caporaletti et al. disclose a security substrate with at least one interference filter embedded therewithin and covered with an opaque layer having a window in register with the interference filter. However, '027 does not disclose a second optical structure that would be visible through a light transmissive window of the first optical structure and would include a reflector layer to provide highly specular visual references for an image formed by the interference filter.

In '042 Holmes et al. teach a security device consisting of a hologram on the background of a color shifting multi-layered foil. An image provided by the device disclosed in '042 is a diffractive image on a color shifting background. Use of a relief pattern for forming the diffractive image greatly impedes rendering photographic-like images on the surface of the article, the practice often used in manufacturing of banknotes and other documents of value. For a photographic representation, it is preferably to have an absence of relief areas in the image area. Additionally, the device taught by '042 is a complex device wherein a patterned Al layer should be deposited in register with the embossed surface.

It is an object of the instant invention to provide a cost effective and easy to manufacture security article consisting of two optical structures, wherein one structure is visible through a window of another structure, for providing an entirely specular color shifting image having visual references therewithin for a higher level of counterfeit protection.

A major impediment to providing a patterned layer within a multilayered thin film structure was residual oil remaining on the images and on non-patterned areas of the web. This residual oil was detrimental to further thin film coating since left over oil would cause “ghosting”; a process whereby the inhibiting oil is transferred to the back side of plastic film when roll coating, which in turn causes inhibiting oil to be transferred further down the web on the front side. Left over inhibiting oil also causes adhesion failures to subsequent thin film layers.

“Ghosting” and the ability to remove residual inhibiting oil is overcome by this invention. By way of this advance, for the first time, patterned multilayer optical stacks could be conveniently manufactured in a cost effective way on a security thread, by roll coating. In particular, a new optically variable security thread that had a high pattern resolution was made that contained readable text or graphic images where covert features such a magnetic signatures could also be incorporated.

It is an object of this invention, to provide a security thread having optically variable features such as an optically variable pattern that can be seen against a background that is distinguishable from the pattern, or from which the pattern stands out.

It is a further object of this invention, to provide a relatively simple, inexpensive method of manufacture of a multilayer patterned security thread for use within or upon a web or sheet, for example on currency, documents or packaging for providing authentication thereof.

### SUMMARY OF THE INVENTION

In accordance with this invention, there is provided a security thread for embedding within or upon a sheet or document, comprising: a first optical structure consisting of a plurality of layers, wherein the plurality of layers includes a patterned layer of coating material having a first region wherein the coating material is present and a second region wherein the coating material is absent, wherein the plurality of layers form an interference filter in the first region and a light transmissive window adjacent to the interference filter in the second region; and a second optical structure including a reflector layer; wherein the first and second optical structures are so located as to allow a part of the second optical structure to be visible through the light transmissive window of the first optical structure.

In accordance with this invention there is provided, a security thread for embedding within or upon a sheet or document, comprising:
an elongate substrate having a first side and a second side;
an optically variable structure deposited on one of the first and second side of the elongate substrate, wherein the optically variable structure comprises a thin film interference structure which has the appearance of a plurality of separated interference filters arranged side-by-side and spaced from one another having visible color shifting properties in the form of a visible pattern of visually separated distinguishable indicia against one of a foreground and background of a different color.

This invention provides a security thread providing security to a sheet, document or packaging, wherein thread has a visibly optically variable structure thereon that is visible from at least one side of the sheet; although the optically variable structure may be a continuous plurality of layers forming a large Fabry-Perot cavity or interference filter, by providing a patterned layer in front of the Fabry-Perot cavity, the interference filter appears to be separate spaced filters. In another embodiment plural separated filters are provided which similarly appear as separated optically variable structures.

In accordance with this invention there is provided, a sheet having a security thread embedded therein or disposed thereon, the security thread comprising:
a substrate having a first side and a second side;
a plurality of separated n-layered Fabry-Perot cavities deposited upon the first side of the substrate, side-by-side, wherein the Fabry-Perot cavities are spaced from one another, wherein each n-layered Fabry-Perot cavity is a thin film interference filter having visible color shifting properties; said plurality of cavities being arranged along the substrate to form a visible pattern as a result of the color shifting properties.

In accordance with another aspect of this invention there is further provided, a security thread for imbedding within or disposing upon a sheet, wherein the security thread comprises a plastic web upon which is deposited layers of thin film color shifting coatings forming side-by-side, spaced apart interference filters, wherein the interference filters are seen as patterns against a background of a different color.

In accordance with one embodiment of this invention, a continuous Fabry Perot structure having plural layers defining one or more cavities can be applied to one side of a web or substrate. On a second side of the web, a pattern of aluminum or some other material visibly distinguishable from the Fabry Perot structure can be applied using an oil ablation process. Visually when one views the thread from the patterned aluminum side, the portions absent aluminum show as optical variable regions, and the portions with aluminum present show as contrasting aluminum regions. Hence in this embodiment, the continuous Fabry-Perot structure reveals to the viewer from the patterned side, plural side-by-side spaced FP cavities since the aluminum masks portions providing the pattern.

In accordance with yet another aspect of the invention there is provided a method for forming an optically variable device comprising the steps of:
patterning a reflective layer on a web substrate having a first side and a second side using an oil-ablation technique to form a patterned reflective layer;
removing oil residue from the first side of the web and depositing thin-film layers on the web substrate to form the optically variable device.

In accordance with another aspect of the invention there is further provided a method of patterning metal comprising the steps of:
applying a non-wetting oil to selected portions of a first surface of a web substrate to create an oil pattern;
depositing metal on the first surface of the web substrate wherein the non-wetting oil ablates depositing metal from the oil pattern; and
removing oil residue using a first glow discharge applied to the first surface of the web and a second glow discharge applied to a second surface of the web.

In accordance with another aspect of the invention there is provided a machine-readable security device, comprising a web having disposed thereon, a patterned layer of magnetic material sandwiched between two metal layers.

In accordance with the invention a machine-readable security device is also provided wherein a security thread includes a magnetic material patterned thereon using an oil-ablation process.

The use of an oil ablation process is a preferred embodiment, allowing the coating and removal of a rolled on pattern within a coating chamber to yield a patterned web having a visible patterned interference structure. Notwithstanding, it is within the scope of this invention to use of other materials having similar properties to oil, wherein its removal is compatible with the coating of subsequent layers in situ. Alternatively, but less preferably, a water soluble polymer coating that can later be removed by washing is possible, however temporary coatings of this sort are not as useful as the application of oil, which can be removed within the deposition chamber.

This invention circumvents difficulties encountered in wet chemical etching methods for patterning by providing a novel security thread that is optically variable either in reflection or transmission with text or other patterns by using an all-dry process, in-line, in a vacuum roll coater. The human eye can readily see the optical performance of the thread as a color shift as the thread is tilted back and forth. Either the text or pattern is optically variable against a transparent or shiny reflective background, or alternatively the background is optically variable against the text or patterns that can be easily viewed in transmission. Furthermore, the thread and its pattern can be distinguished from the background of the sheet, which carries it. Alternatively, the thread can be viewed in reflection where the imagery appears to be colored or optically variable using foil or color shifting ink against a reflective background of aluminum or other colored metal such as copper, or an optically variable, or a non-optically variable thin film optical stack. Alternatively, an embodiment of the invention provides the inverse or negative image of the above-mentioned structures. The optically variable optical stacks can take the form described in U.S. Pat. Nos. 4,705,356; 4,838,648; 5,135,812; 5,214,530; 5,278,590; 6,157,489; 6,241,858; 6,243,204; 6,241,858; 6,569,529; and 6,699,313 to Phillips, an inventor of this invention. In addition, mica based interference pigments such as TiO₂ or Fe₂O₃ coated micas can be used as the color shifting pigments in the color shifting inks.

Various embodiments of this invention are described and shown in detailed description and accompanying figures. The thread can either be windowed into the banknote in much the same manner as that found in European patent application EP1258334 A3 in the names of Cunningham, and Brian or can be applied across the surface of the banknote.

Such threads as described in accordance with this invention cannot be accurately reproduced by way of being photocopied, photographed, or printed since these technologies do not possess optically variable effects. Furthermore, in the case of optically variable foil, the optics of copiers prevents even the face color at normal incidence from being imaged; since just a black image results as the reflective surface of the optically variable thread causes the light to miss the entrance optics of the copier. In addition, the intricate design of the text, having a resolution down to 60 microns, would prevent any counterfeiter from using scissors to simulate this security device.

### BRIEF DESCRIPTION OF THE DRAWINGS

Exemplary embodiments of the invention will now be described in conjunction with the drawings in which:

FIG. 1 is a diagram illustrating a prior art device wherein a layer of patterned aluminum on a PET substrate or web.

FIG. 2 is a cross sectional view showing an embodiment of the invention wherein interference structures are shown created by layer of patterned aluminum on a PET web covered with a spacer layer of MgF2 capped by a Cr layer, the three layers forming a plurality of optical interference structures, side-by-side having windows, therebetween.

FIG. 3 is a cross sectional view of a layered structure with patterned aluminum on one side of a PET web, an optically variable foil coating on the same side of the PET web, and a different optical coating on the other side of the PET web.

FIG. 3b is a cross sectional view similar to that of FIG. 3, with the addition of an embossing of the plastic layer.

FIG. 4 is a diagram of an embodiment illustrating a patterned magnetic layer on a PET web.

FIG. 5 shows an embodiment of the invention wherein a patterned magnetic layer is sandwiched between two layers of aluminum on a PET web.

FIG. 6 shows an embodiment with a patterned aluminum layer on one side of a PET web and an optically variable foil with a hidden magnetic layer on the same side of the PET web.

FIG. 7 is an illustration showing a patterned aluminum layer deposited on a plastic substrate over-coated with color shifting ink on one side of a PET web.

FIG. 8 shows the effect of positive and negative patterned aluminum layer over-coated with color shifting ink layer on one side of a PET web.

FIG. 9 is a diagram of an embodiment of the invention wherein a patterned aluminum layer is deposited on one side of a PET web and a color shifting ink layer is coated on the opposite side of the PET web.

FIG. 10 is a cross sectional view illustrating a patterned aluminum layer deposited on one side of a PET web over-coated with a protective layer of abrasion resistant lacquer and a color shifting ink on the opposite side of the PET.

FIG. 11 shows a patterned aluminum layer over-coated with a Fabry-Perot design on one side of a PET web and coated with a second different Fabry-Perot design on the second side of the PET.

FIG. 12 is a cross sectional view of a patterned aluminum layer on one side of the PET web and a continuous optical structure on the second side of the PET.

FIG. 13 shows a patterned colored shifting foil and one side of the PET and a printed layer of ink (black or complimentary color to the color shifting foil) on the second side of the PET.

FIG. 14 is a cross sectional view showing a Fabry-Perot design on a PET web where the dielectric spacer layer is patterned.

FIG. 15 is a cross sectional view showing a Fabry-Perot design on a PET web where the absorber layer is patterned.

FIG. 16 is a diagram, which illustrates a simplified coater according to an embodiment of the invention.

FIG. 17 is a diagram which illustrates a cleaning arrangement within the coating chamber to remove residual “inhibiting oil”.

FIG. 18 is a view of a one dimensional magnetic bar code pattern hidden within the aluminum layers, wherein the Al layers are conveniently shown in this figure to be transparent so that the bar code can be seen.

FIG. 19 shows a two-dimensional magnetic bar code pattern hidden within the aluminum layers.

FIG. 20 shows the resolution of a text symbol in a patterned optically variable security thread.

FIG. 21 is an illustration showing a patterned optically variable thread embedded into a bank note in a windowed type format.

FIG. 22 is an illustration showing the text of the patterned optically variable thread in a bank note viewed in transmission.

FIG. 23 shows a graphic security label formed from a patterned optically variable foil structure on a pressure sensitive adhesive-releasable label paper stock.

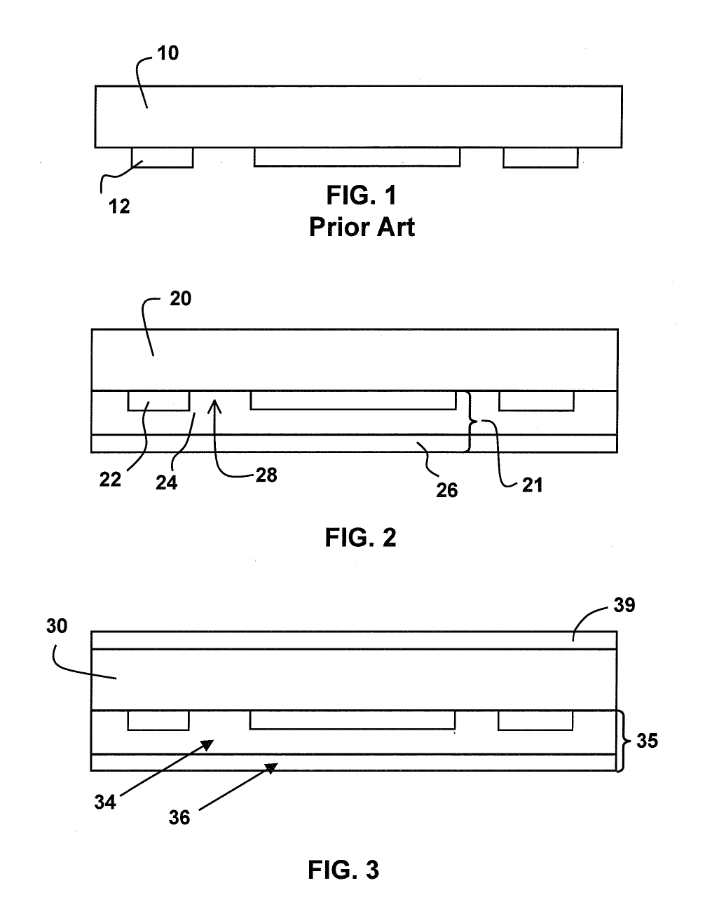

### DETAILED DESCRIPTION

Referring now to FIG. 2 a layer of patterned aluminum 22 on a PET web 20 is shown. This embodiment is not limited to the use of aluminum as a reflector material and other reflecting materials, for example another reflecting metal could be used instead of aluminum. The PET web forms the base of the security thread upon which the layers shown are deposited; however other materials, such as other plastics could be used in place of PET. The aluminum patterned layer 22 is covered by a spacer layer 24 of MgF2 deposited over the patterned aluminum and web which forms windows 28 in regions over the web absent the deposited aluminum; a layer of absorber material 26, such as a thin layer of chromium, is deposited over the spacer layer 24. An optical interference structure is formed from the reflector/dielectric spacer/absorber (R/D/Ab) stack over the remaining portions of the patterned metal, but not over the portions of the web where the Al has been removed; these portions were Al has been removed are referred to as window portions. The optical interference structure(s) 21 can be color filters that gives the patterned metal a particular appearance, or one that gives the patterned metal a color-shifting, “optically variable” appearance. The aluminum is patterned by printing an image or pattern onto the plastic web 20 using the “inhibiting oil” and then depositing a thin film of aluminum. Although the exact mechanism by which the oil prevents the sticking of the vacuum deposit to the substrate may not be entirely understood, the process nevertheless works. Various theories have been proposed to explain this phenomenon. One theory invokes the idea that the heat of condensation of the depositing material turns the oil into a gas and in effect ablates the metal away. Another explanation is that the oil simply prevents nucleation of the depositing material and hence the arriving material is scattered away.

In the embodiment shown in FIG. 2 the Al—MgF₂—Cr stacks each form a Fabry-Perot (“F-P”) absorber-spacer-reflector-type optically variable device (“OVD”), which are not formed over the window portions of the web because there is an absence of a Fabry-Perot structure in these areas. The plastic web can be clear, tinted, translucent, or opaque, and the materials chosen for the patterned metal layer and overlying thin films are merely exemplary. After coating the thin-film layers, a protective layer is optionally applied, such as a thin layer of lacquer, not shown, or a thin (e.g. 0.5 mil) plastic film that is adhered to the OVD using laminating adhesives.

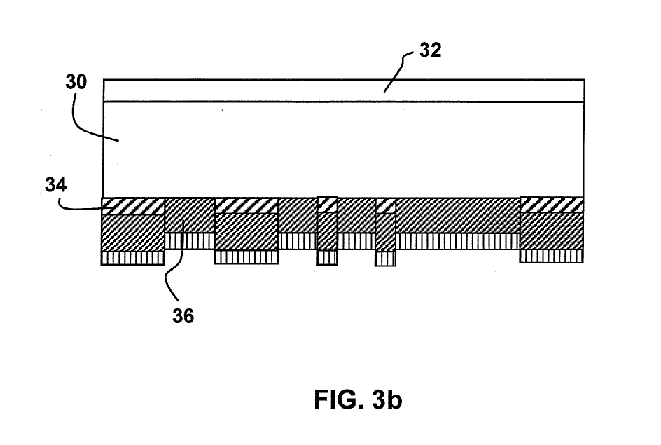

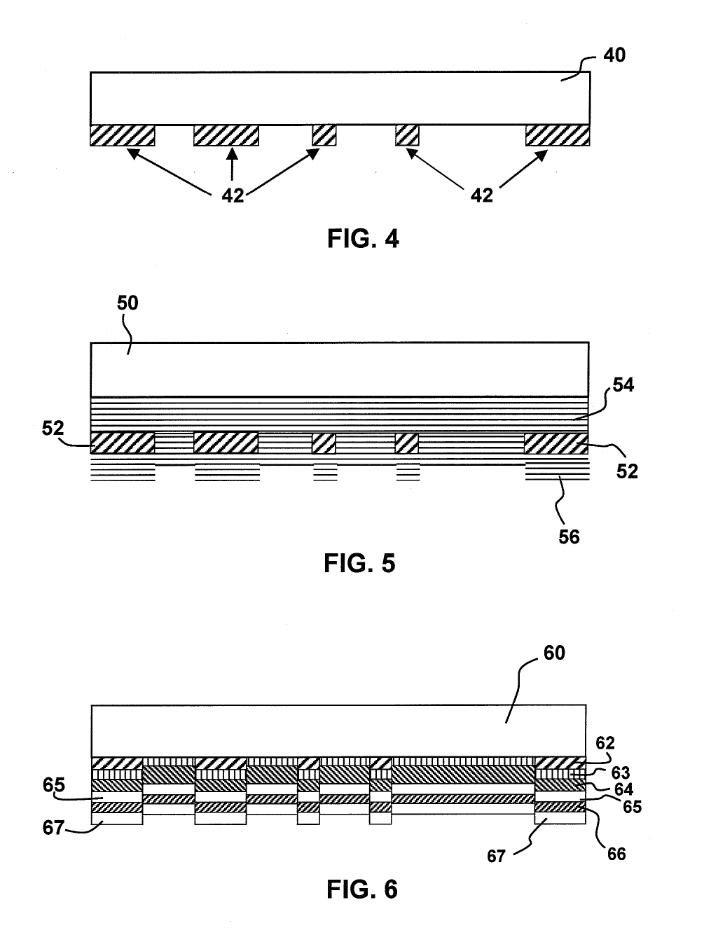

FIG. 3 shows a layer structure, similar to that of FIG. 2 on a front side of a web 30. Patterned aluminum is deposited after using a roll-coater with inhibiting oil to apply a pattern of oil to prevent permanent deposition onto predetermined regions of the web 30 on a “front” side of a PET web. Layers 34 and 36 of MgF₂ and Cr are deposited over the front side to form optical interference structures over the Al; the Al serves as a reflector in the Fabry-Perot structure(s). Another optical structure 39 is formed on the “back” side of the web, so that it is visible through the light transmissive window of the optical structure formed on the front side of the web. The second structure 39 can include one or more layers such as a reflective layer, an optically variable (OV) layer, a magnetic layer, or a fluorescent layer. For example, the reflective layer can be a continuous reflective layer, a patterned layer, or a coating having reflective flakes therein. Preferably, the reflective layer is planar for providing a mirror-like image. The OV layer can be made of OV foil or a coating with OV flakes dispersed therein. The magnetic layer is either continuous or patterned as it is described hereinafter, in particular with reference to FIGS. 4, 18, and 19, either sandwiched between layers of aluminum as shown in FIG. 5, or a single layer. In this embodiment, a protective layer is optionally applied to both surfaces of the OVD.

In accordance with this invention, in the embodiment where a magnetic layer is sandwiched in between the reflective layer, as is described in United States Patent application number 2002/0160194A1 and WO 02090002(A2), in the name of the same inventor, a covert signature is present. A number in digital code or as in a bar code may be present, that is unseen by the naked eye, and may be fore validating the serial number on the bill or the denomination for example, $50.00.

In this embodiment, where a magnetic bar code is hidden within the device, it exhibits the same reflective properties as aluminum but has a magnetic signature that can be read with appropriate magnetic detectors. The magnetic detection may be just the presence of a magnetic material as in a magnetic image such as a hidden bar code or a hidden logo, or may be a signal of digital or analog recorded information.

In accordance with this invention, the thickness of the magnetic layer is preferably between 0.1 and 1.0 microns in thickness. In the prior art, it is known to use a thick layer for example having a thickness of 12 to 13 microns. Notwithstanding, this invention can provide a very thin layer that is detectable by providing a continuous layer of magnetic metal or metal that is detectable by magnets. Thinner layers are advantageous for use with security threads to be imbedded in or on currency so that a large stack of bills do not pile up at an angle when stacked. Furthermore, providing thinner layers ensures that that overall thickness of the thread remains relatively thin, which is desired. Hence, the thickness of the magnetic layer should be less than 5 microns and preferably less.

In the simplest case, as shown in FIG. 4 a single layer 42 of magnetic material may be deposited onto the plastic web 40, patterned by the oil imaging method, and then formed into a security thread, label or hot stamp image. In more complicated structures, the patterned magnetic layer 52 supported by a substrate 50 is sandwiched between two layers of aluminum 54 and 56 as is shown in FIG. 5 or is sandwiched between two layers of aluminum in a Fabry-Perot optical stack shown in detail in FIG. 6 wherein a substrate 60 has deposited thereon a patterned aluminum layer 62; upon the layer 62 is a Cr layer 63 a dielectric layer 64, and a magnetic layer 66 between two Al layers 65 and 67 upon the dielectric layer 64. In the instance where only one side of a security thread is visible, the magnetic layer 66 can be covered by a single layer of aluminum 67 and need not be sandwiched between two such layers. Alternatively, the magnetic layer acts as a reflector in the Fabry Perot filter consisting of layers 63, 64, and 66 in the embodiment where reflective layers 65 and 67 are absent.

Referring now to FIG. 5, a cross-sectional view is shown wherein a plastic substrate 50 has deposited thereon a non-magnetic layer 54 of aluminum. Of course other non-magnetic materials could be used. A pattern of inhibiting oil is then applied to create a predetermined bar-code pattern of oil dependent upon the design upon the rollers that pick up the oil and coat the plastic web 50. The magnetic layer 52 is subsequently deposited and magnetic material only remains where no oil has been applied during the vacuum coating and cleaning process. A final layer of non-magnetic material 56 effectively sandwiches the magnetic layer 52 between the two non-magnetic layers.

In an alternative embodiment, one could use an additional layer over a patterned layer to serve as a leveling layer. This could be done by evaporating an organic smoothing layer in vacuum and curing by cross linking as taught by Yializis in U.S. Pat. No. 6,706,412. Patterning for multilayers could take place on unpatterned regions or even on previously patterned regions.

FIG. 6 is a more complex structure than that of FIG. 5, however the method of manufacture is essentially the same, patterning and depositing subsequent layers.

In yet another embodiment of the invention the combination of a patterned OV thin film foil shown in FIG. 2 with color shifting ink, wherein the ink is disposed between the foil and a substrate or on the other side of the substrate opposite to the side supporting the patterned foil, including but not limited to inks containing pearlescent type pigments based on coated mica, SecureShift® colors (registered to Flex Products), optically variable ink (OVI®, registered to SICPA), inks based on diffractive based pigments or liquid crystal color shifting inks can be present. The pigment may be formed of flat thin film optical structures or may be formed of diffractive flakes as described in U.S. Pat. No. 6,692,830 and PCT patent application WO 03011980A1.

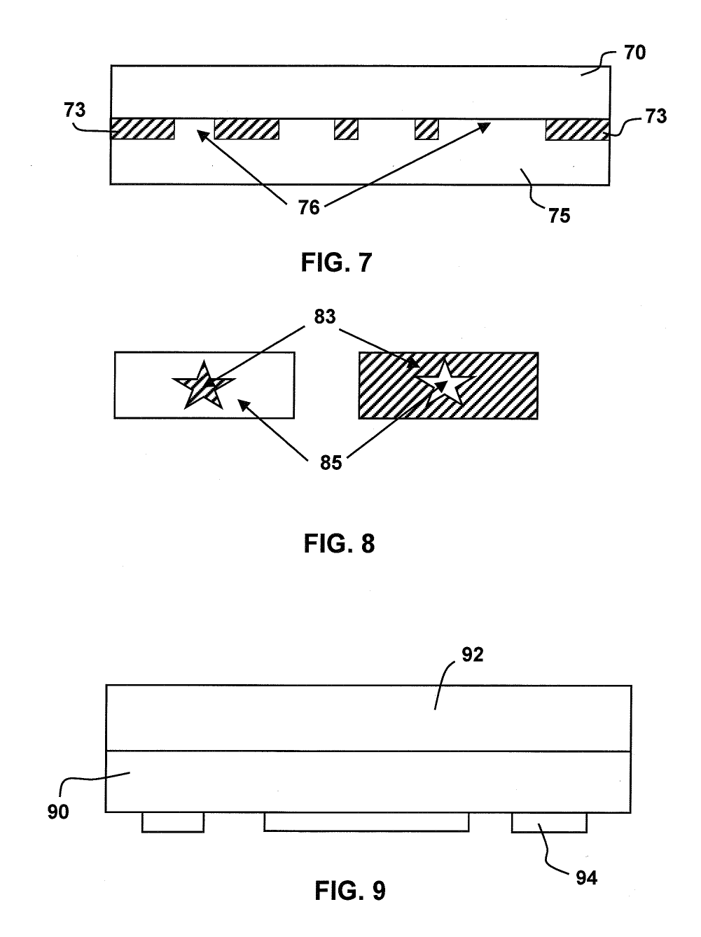

Referring now to FIGS. 7 and 8 the embodiment of the invention are shown that utilize color-shifting ink. In this instance, the color shifting ink 75 is visible through the holes or windows 76 in the patterned thin film 73. In the simplest case, a patterned aluminum 73 is formed on a plastic film 70 such as polyester terephthalate (PET) and the color shifting ink 75 is coated over the patterned aluminum so that from the opposite side, one sees a color shift with viewing angle through the text or graphic images or appears as background around reflective text or graphics. In another embodiment of the instant invention, layer 73 is a patterned color shifting foil covered with color shifting ink 75 with color shifting flakes dispersed therein, each flake including a reflector layer. In operation, one optical structure formed by the color shifting ink would show through the windows of another optical structure consisting of the patterned Fabry Perot foil, thus forming an optical device where both optical structures have very different color shifts or could have the same color shift in hue but very different brightnesses, ink having lower brightness than foil of the same color. Alternatively, the color shifting ink is coated onto the substrate and the patterned Fabry Perot structure is disposed over the ink.

In FIG. 8 is an illustration showing that the background can be non-color shifting and foreground color shifting or vice versa.

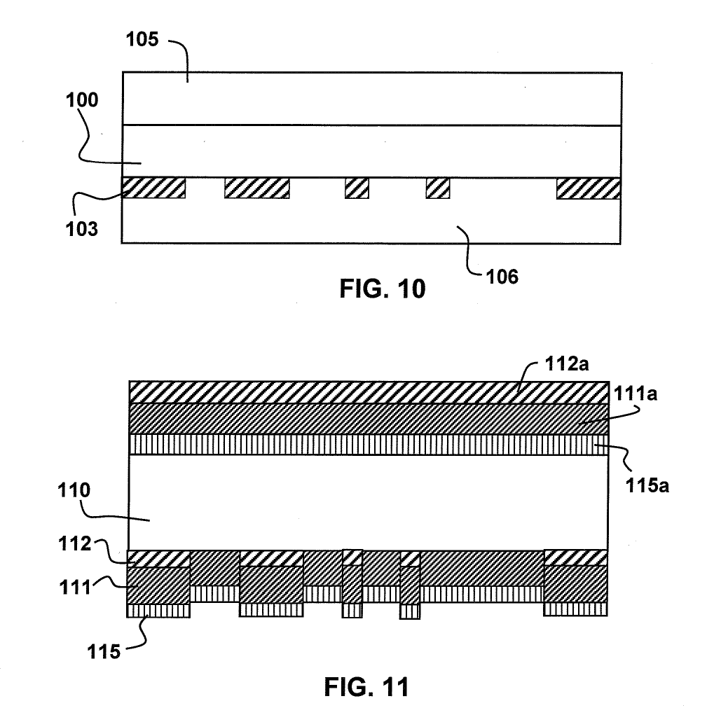

Alternatively the color shifting ink is coated onto the surface opposite the patterned aluminum so that one views the security device from the patterned aluminum side. In this instance, the color shifting ink shows through the openings of the patterned aluminum. As in embodiments described heretofore, the patterned aluminum can have an additional protective layer placed upon it, such as a scratch resistant lacquer or is laminated to a thin PET sheet typically having a thickness of 0.5 mil or less. FIGS. 9 and 10 exemplify these structures.

In FIG. 9 a plastic web 90 has on an upper side thereof, an optically variable structure 92, for example in the form of optically variable ink, color shifting ink, optically variable pigment or a thin film Fabry-Perot cavity structure. On a lower side of the web, a patterned layer of aluminum 94 is shown. In FIG. 10 a color shifting ink layer 105 is disposed upon a plastic substrate 100 and a patterned layer of aluminum 103 is deposited on the lower side of the substrate 100 having a protective lacquer coating 106 over it.

In one embodiment shown in FIG. 3, a layer of opaque aluminum is coated on the back side of the substrate, so that the window portions of the patterned layer supported by the front side of the substrate appear reflective. The backside reflector does not typically form an OV structure with the front side MgF2-Cr layers because the intervening PET web is relatively thick for use as a spacer in a Fabry-Perot structure in the visible range of light. The window portions appear mirrored, while the front-side F-P structures provide an OVD as shown in FIG. 3. The optical effect provided by this structure is entirely specular, and mirror-like highly reflective regions provide a visual reference for the OV image formed by the front-side structure.

Alternatively, a second optical structure on the backside of the web is an optical interference structure. FIG. 11 shows a first optical structure on the front side of plastic substrate 110, preferably a PET web, including patterned aluminum layer 112, followed by dielectric layer 111 having a layer of Cr 115 on top. The second optical structure consists of absorber layer 115a on substrate 110, spacer layer 111a over absorber layer 115a, and reflective layer 1 12a over spacer layer 111a. The second F-P structure provides a color shifting effect visible through the windows of the first F-P structure located on the front side of the device. Preferably, the color shifting effects provided by the two structures are different and one OV image can be used as a reference for another OV image. Optionally, the second Fabry Perot structure is also patterned.

Alternatively, in a security article similar to one shown in FIG. 11, reflective layer 112a is deposited onto substrate 110, and followed by spacer layer 111a, and absorber layer 115a. The reflective backside layer 112a is particularly desirable for a security article with an OV front structure, because the mirror-like background provides a good visual reference to the color change of the frontside OVD. This reflective backside layer also serves as a layer in the optically variable structure defined by the two adjacent layers; a Cr layer 115a, a dielectric layer 111a. This security article can be viewed from both sides. It provides an OV image on one side, and an OV image with highly reflective references on the other side.

In the aforedescribed security articles consisting of one OV structure visible through windows of another OV structure, a reflective layer of one of the optical structures can include magnetic material, either entirely forming the reflective layer, or a magnetic sublayer, patterned or non-patterned, hidden under one or sandwiched between two sublayer of a highly reflective material such as aluminum, thus forming a composite reflective layer, as described in reference to FIGS. 4-6 heretofore.

Alternatively, a layer of OV ink may be applied to the backside of the web. The application of the OV ink to the backside of the web enables an optically variable (OV) effect when the structure is viewed from either side. When viewed from the backside, the OV effect of the ink is observed. When viewed from the front side, the OV effect of a windowed optical structure such as shown in FIG. 2 is observed, in addition to the OV effect of the ink. The OV ink can be a carrier having reflective flakes or color-shifting flakes dispersed therein. A reflective material within the flakes forms a reflective layer on the backside of the web and provides a specular image, either silver colored or color shifting.

Advantageously, a security article comprising two optical structures in accordance with the instant invention provides an additional level of protection against counterfeiting. When this security article is used e.g. as a security feature in a banknote, the first optical structure including one or more interference filters forms an entirely specular OV image, and the second structure visible through the light transmissive window of the first structure provides an optical reference, reflective or color shifting, to the image formed by the first optical structure, making this image more difficult to counterfeit and thus providing an enhanced level of protection. The capital cost to manufacture such a device is prohibitively high for the causal counterfeiter and for professional counterfeiters.

Advantageously, the light reflected by the security device of the present invention is entirely specular, which is important for rendering photographic-like images on the surface of the article, the practice often used in manufacturing of banknotes and other documents of value. For a photographic representation, it is preferably to have an absence of relief areas in the image area. With the instant invention, photographic quality images down to 50 microns are realizable, that color shift from one discrete color to another. A further advantage of this instant invention is that the color images are viewable at all angles both in tilt and in rotation. With a diffractive image, such as formed by a device disclosed in '042, the color of the image depends on the orientation of the grooves and ridges relative to the light source and will fade in and out as the article is tilted and/or rotated.

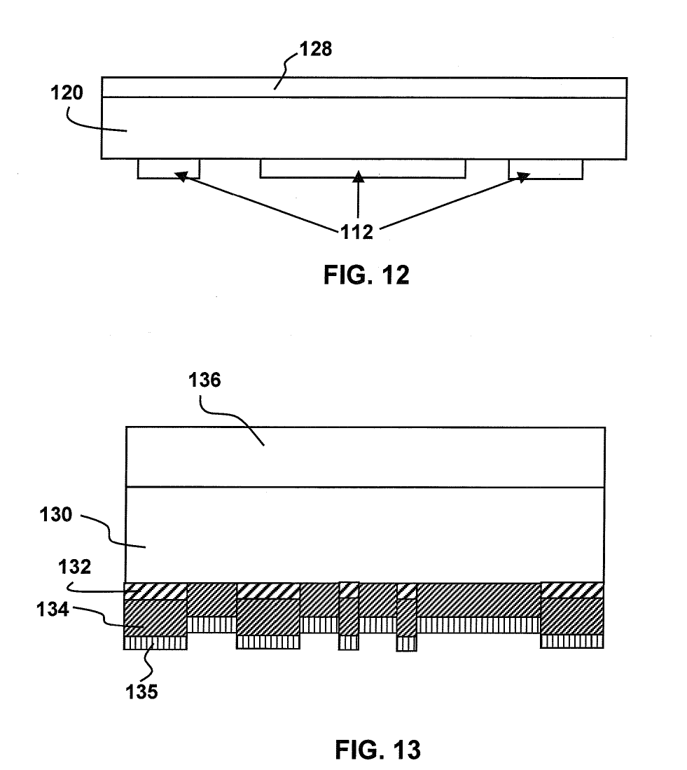

Turning now to FIG. 12, a PET web 120 is shown with patterned aluminum 112 on the front side and an optical structure on the backside. In one embodiment the optical structure is an organic layer 128 containing Anti-Stokes material in the form of powder. The Anti-Stokes layer fluoresces at a shorter wavelength when illuminated at a longer wavelength. Many suitable materials exist, and are typically applied to the backside of web as very fine particles in a carrier. Powdered Anti-Stokes material is available from STAR DUST TECHNOLOGIES. The particles are generally light-colored, such as a cream or a light tan color, and fluoresce in a color, such as blue, green, yellow, or orange when irradiated with near IR light, which is outside the visible range. Thus, when the window portions are irradiated with the near IR light, the window portions fluoresce in a visible color. This can be used as a covert security feature because the Anti-Stokes coating is not easily seen by casual observation.

Alternatively, shown in FIG. 13, a patterned optically variable foil comprising a patterned layer of aluminum 132, a dielectric layer 134, and a Cr layer 135 may be formed on one side of the PET and a printed layer of regular ink 136 is printed on the second side of the PET substrate 130. The printed ink 136 is either black in color or is a complimentary color to the normal (90 degree) color of the color shifting foil. In this case, the black or complimentary color shows through the windows of the patterned OVD or in the reversed image, the black or complimentary color layer acts as a background or reference for the color shifting patterned text. For instance, a green to blue color shifting foil would have a magenta printed ink on the second side of the PET; for example, green and magenta are complimentary colors. In both instances, the contrast between the printed ink layer and the color shifting foil allows easy viewing in reflected light. A matching color could also be printed so that the reflected colors of the text only show up at other angles than the one at normal.

In an embodiment shown in FIG. 3b, substrate 30, such as a plastic film, has an embossed surface coated with an aluminum layer 32 on the side opposite the patterned reflective coating 34 so that the holographic imagery or diffractive imagery shows through the windows 36 of the Fabry-Perot structure aforedescribed in reference to FIG. 3. Looking at the bottom of the article, one would see the holographic or diffractive features though the windows of the OV structure. The embossing could be done on the substrate followed by the Al opaque coating or the embossing could be done by hard embossing into the aluminum layer after it had been deposited onto the substrate.

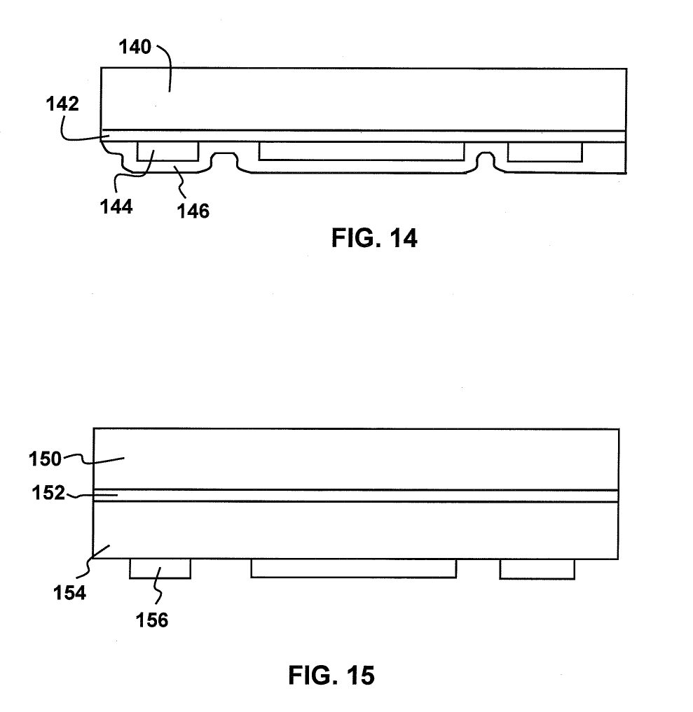

FIG. 14 shows an OVD (optically variable device) formed on a web 140 wherein a reflective layer 142, such as an Al layer is deposited, and an overlying spacer layer, such as an MgF2 layer 144, is patterned, with the oil-“inhibiting” technique. An absorber layer 146, such as a thin layer of Cr, is deposited over the underlying layers to form OVDs where the reflective, spacer, and absorber layers form an F-P structure. As with the OVD shown in FIG. 3 wherein the optical structure on the backside is a reflective layer, the embodiment shown in FIG. 14 may have highly reflective regions proximate to the OVD structures that provide visual references when observing the OVD. In another embodiment, more dielectric layer material can be deposited onto the patterned dielectric so that a color-shifting pattern is formed on top of a different color-shifting pattern, once the final absorber layer has been deposited.

FIG. 15 shows an OVD formed on a web 150 with reflective and spacer layers 152 and 154 respectively formed on the web and an overlying patterned absorber layer 156. The absorber layer is patterned using the oil-ablation techniques. An OVD is formed where the absorber material remains. In another embodiment, the reflective and absorber layer are both patterned.

In one embodiment of the present invention, one side of a substrate supports an optical structure shown in FIG. 15, wherein the absorber layer 156 is patterned and the reflective layer 152 is a partially transparent layer described in more detail hereinbelow, thus forming a layered semitransparent structure having optically variable partially transparent regions, where absorber material is present, and partially transparent non-OV windows where absorber material is absent. The windows have a slight gray color provided by the partially transparent reflector layer. Optionally, the substrate is printed with information (not shown in FIG. 15), under the semitransparent structure or on another side of the substrate. The printed information can be seen though the windows as well as through partially transparent optically variable regions. The printed information can be printed backwards in the windows so that in viewing the printed information though the substrate, the words are oriented normally. Regular or OV ink can be used for printing. Regular printing inks are made from absorption pigments or dyes dispersed in a printing media. They are the everyday inks found printed in newspapers and magazines. Various OV ink have been specified hereinbefore. In another embodiment, the second side of the substrate is covered with a reflector layer, as it is described in reference to FIG. 3, to provide a visual reference to the color shifting image formed by patterned structure on the first side of the substrate. In another embodiment, the spacer layer can be patterned as it is shown in FIG. 14.

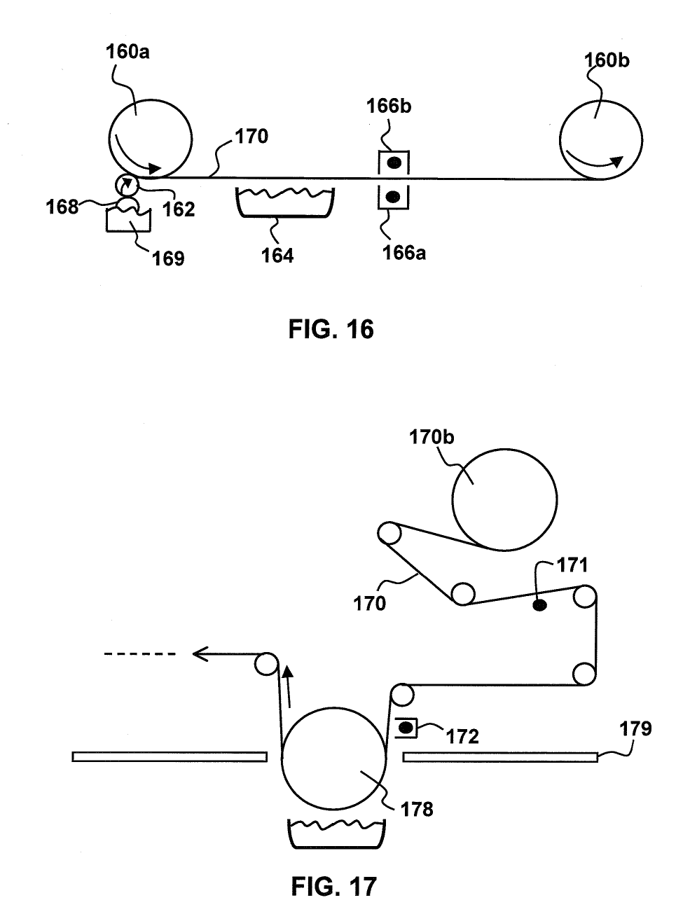

FIG. 16 shows a simplified coating machine according to an embodiment of the invention. The coater includes an unwind roller 160a, a wind roller 160b, a printing head 162, an evaporation boat 164 and glow discharge elements 166a and 166b. In operation, the printing head 162 receives the “inhibiting oil” oil from the pick-up roller 168 from pan 169 and applies the oil to a PET web 170.

The oil has the property that it does not readily evaporate in the vacuum of the roll coater, but readily evaporates when subjected to the heat of condensation of the evaporating material. In addition, the oil has the property that is does not spread on the surface of the plastic web i.e. there is little, if any, dot gain.

The oil must stick to the substrate but not spread beyond the image area that is printed. Ideally, it should have an interaction with the plastic web but not spread. If it spreads beyond the image of the imprinting cylinder, the image will not be faithfully reproduced. If the graphic images are in pixel form, it is important that pixels are distinguishable from one another and do not have edges or portions that run into each other. Such an unwanted increase in pixel size is known as dot gain. For very thin layers of oil it likely does not make any difference whether it is wetting oil or non-wetting oil. However, it is preferable that oil not bead up. If the oil was thick and non-wetting, it would simply bead up and run off of the web and not maintain the printed image. The spreading of one material on another is determined by the respective surface energies, γA, γB and γAB, where γA is the surface tension ( ie. surface energy) of the plastic web, γB is the surface tension of the oil and γAB is the interfacial surface tension. Spreading is determined by the equation S_{L/S}=γA−γB−γAB, where S_{L/S} is the spreading coefficient. If S_{L/S} is positive, spreading will occur. In other words, γA is larger than the sum of γB and γAB which means (γB plus γAB) has a lower surface energy than γA. Thus, to minimize energy, spreading will occur. Therefore, S_{L/S} should be negative so that spreading of the oil on the plastic substrate does not occur. As mentioned above, spreading would be detrimental since the dot gain would reduce the resolution from the original print image on the patterned imaging roller. The oil also has a low vapor pressure so that it does not evaporate after printing the image onto the web. FOMBLIN or Krytox oils meet the spreading criteria; however, other low vapor pressure oils may be used depending on the substrate being used.

In operation, the web is advanced to the evaporation boat, which deposits Al or other material on the surface of the web. Process conditions are controlled so that the heat of condensation of the Al vaporizes the oil where it underlies the Al, removing the Al from the regions that previously had oil. An alternate explanation is that the oil prevents nucleation of the depositing aluminum, i.e. the aluminum does not stick and re-evaporates into the chamber. However, even though the process occurs under vacuum, it was discovered that either products of oil breakdown and/or residual oil (generally “oil residue”) may be present on some portions of the web, including the backside of the web after vacuum deposition. Such residue can degrade the optical performance of OVDs subsequently formed on the web and prevents acceptable adhesion of subsequent then film layers. It is very difficult to even detect the presence of such residue, absent forming an OVD and evaluating its optical performance. Ghosting, smearing, and other undesirable effects were observed when thin-film OVD structures were deposited on webs with patterned Al without some cleaning of this residual oil. The Al was deposited and patterned in one vacuum coater, and the OVDs were deposited in another vacuum coater. It was found that oil residue removal can be performed in the Al coater after patterning, in the OVD coater before deposition, or that a single vacuum roll coater can be used to deposit and pattern the Al and to deposit the OVD layers, with an intervening cleaning.

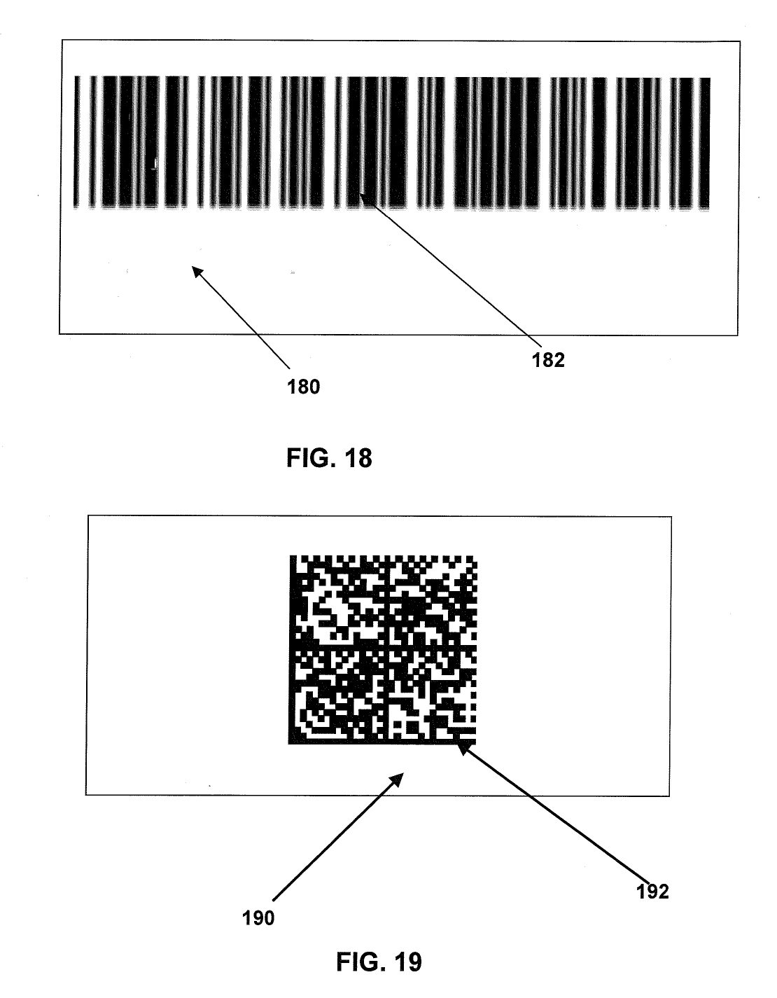

A glow discharge cleaning technique was used to successfully remove oil residue. Several types of glow discharge cleaning techniques were evaluated, as well as other cleaning techniques. A glow discharge cleaning technique using argon gas was tried, but did not adequately clean the residue of the oil used in the patterning process. IR heaters were used before coating, but oil transfer still occurred, presumably because oil transfer between layers of the web occurred. For example, oil residue on the frontside of the web will be transferred to the backside of the web on the wind roll. In an in-line process that coats the OVD before layers of the web are wound together, frontside cleaning of residue may be sufficient. However, with the oil used in this example, it is believed that some amount of cross-contamination occurred during the patterning process, and cleaning both the frontside and the backside was performed, as shown in FIG. 17.

Many additional features of the coater are omitted, such as tensioning rollers and chamber dividers. Similarly, the web may be held against a drum during the Al deposition/patterning.

FIG. 17 shows a simplified depositing apparatus for cleaning a patterned web. The patterned web 170 comes off the unwind roller 170b and along a series of tension rollers. The backside of the web is cleaned at a first station with a first glow bar 171, shown as being unshrouded. The frontside of the web is cleaned at a second station 172 further along the web with a glowbar that is shrouded. The shroud is optionally omitted if the glow discharge does not affect other system components. Similarly, cleaning the backside of the web might not be necessary in all embodiments. Oxygen was provided to the glowbar shroud, but could be provided at other locations of the chamber. The oxygen provided at the shroud diffused to the region of the first glowbar to create the cleaning discharge. A chamber divider 179 keeps material from the OV source(s) from depositing on the tension rollers and other system components. The web is tensioned against a coating drum 178 during deposition of the OV layers. A glow discharge using O₂ as the precursor was found to work well to clean the web of oil residue. Other precursors may be preferred for other oils or liquids, or even for this type of oil residue. In a particular embodiment, a web of PET about 8.5 inches wide was transported through a glow discharge cleaning stage at a speed of 0.5 meters/second. The total current to the backside glowbar and the frontside glowbar was 100 mA and the glowbars were operated at 2,200 Volts. Pure O₂ was provided to the shroud of the frontside glowbar to create a chamber pressure of 5×10⁻³ Torr to remove the residual oil from both sides of the patterned web. An OVD that was formed on the patterned web after cleaning in this fashion showed good optical characteristics, suitable for use in commercial applications.

### FURTHER DESCRIPTION OF EMBODIMENTS OF THE INVENTION

The invention is generally directed toward methods and apparatus for manufacturing imaged foils, as well as security articles including optically variable foils and security labels. In a particular embodiment, an optically variable foil is produced using an all vacuum in-line process.

A substrate consisting of 0.25 to 5 mil PET, preferably 0.5-1.0 mil (1 mil=25.4 microns) is first patterned on the web, width 2″-60″ or more, with a positive or negative image with perfluorinated polyether as described in US publication “Proceedings of the Fourteenth International Conference on Vacuum Web Coating”, Oct. 25-27, 2000 by Aerre Machine. A printing station similar to that described in U.S. Pat. No. 4,749,591 was used and is incorporated herein as a reference. However, the printing method is not necessarily limited to that described in U.S. Pat. No. 4,749,591. For example, other printing techniques may be used include ink-jet printing, flexographic printing, gravure printing or lithographic printing, or even dot matrix printing. In the case of ink-jet printing, it is possible to change the pattern or imagery without breaking vacuum. Advantageously, this allows customized patterns to be created on the plastic roll without the need for a roll on a printing station that requires a pre-imaged print roller. Such patterning with an ink jet process would allow sequential numbering of security labels and other security devices, which is highly advantageous. Multi-layer patterning using a single patterning roll or using different patterns in subsequent thin film layers using the ink jet printing process may be used to create complex graphics or even micro-electronics in the security thread. In particular, a security thread with an optically variable feature may be combined with a hidden magnetic bar code in either one dimension, as in a standard bar code, or in a two dimensions, as in a 2D bar code format. The magnetic layer is hidden between other layers of the thin film design, as for example behind a reflective layer or sandwiched between two highly reflective aluminum layers as shown in FIGS. 18 and 19.

To insure good image fidelity, the printing station should be situated on the cooled drum immediately before the deposition of the first layer, typically aluminum, but may be any material with a heat of condensation sufficient to vaporize the imaged oil. Other substrates such as polyimide, polyhexadiene, polypropylene, polyethylene, polystyrene, polycarbonate triacetate, biacetate, and polynathphanate (PEN) may be used instead of the polyethylene terephthalate (PET). With other substrates and other surfaces, patterning oils based on the fundamental surface energies encountered and required low vapor pressures as described above would be used.

Depositing the first layer that is to be imaged is the next process step to be performed. In the case of an OVD security image that is optically variable, either the reflector layer or the absorber layer may be imaged. In general, any layer may be imaged as long as the oil patterning process produces a discreet oil image. For example, the imaging may occur in the dielectric layer by placing the oil image on the prior-deposited layer. In other words, the reflector layer or the absorber layer may be the layer upon which the oil image is placed. Deposition of a metal layer onto the patterned oil results in explosive evolution of liquid oil into gas, causing the depositing layer to be ablated away. There may be some residual oil (several monolayers of oil) remaining in the patterned area which must be removed in order to this imaged oil from transferring further down the web which would in turn cause ghosting (another image pattern) of any subsequent deposition layers.

In a typical case, the aluminum layer or the chromium layer is imaged and then the rest of the design is added to complete a Fabry-Perot structure, i.e. Al (opaque, patterned)/MgF₂ 1 QW @ 400 nm to 8QW @ 700 nm/Cr 30% T. The low index MgF₂ layer may be substituted by any dielectric material that is highly transmissive in the visible. High index dielectric materials will result in an optically variable foil that is less shifting in color than one that has a large optical shift where a low index dielectric material is used.

In one embodiment of the instant invention, a semitransparent OV device is formed using a partially transparent reflective layer having a thickness below the opaque point. The opaque point is understood as a thickness of a particular material providing less than 5% transparency. For example, a partially transparent aluminum layer having a thickness of less than 20 nm, preferably 10 nm or less, coated with a dielectric layer and an absorber layer, provides a color shifting optical stack that is partially transparent, so that an image or text printed on the substrate under the optical stack, or on the opposite side of the substrate, is visible therethrough. In one embodiment, the substrate is light transmissive so that the OV foil is semitransparent so that information printed on paper and covered with such a foil may be read through this foil. Alternatively, the dielectric layer within the semitransparent OV device may be patterned. All color shifts move from long to shorter wavelengths, i.e. from red-to-blue.

To remove residual oil in the patterned area, an oxygen glow situated right after the deposition source on the cooled drum is used. Glows may also be used on the backside of the web before and after the deposition area. In this instance, the 02 glow will remove any oil from the backside of the web that might have transferred during the “inking process” or flash over during the deposition process that could end up on the back side during wind-up. Typically, the oxygen glow is run at 2,200 volts at 100 ma for a 12″ wide glow system. Residual oil may be detected on the final coated web by noting the variation in color, for example blotches or ghost like images of the original images.

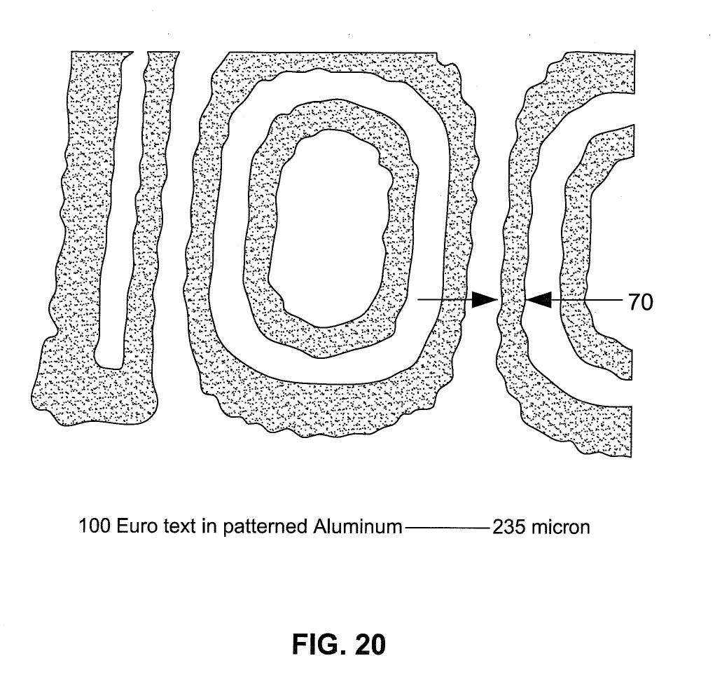

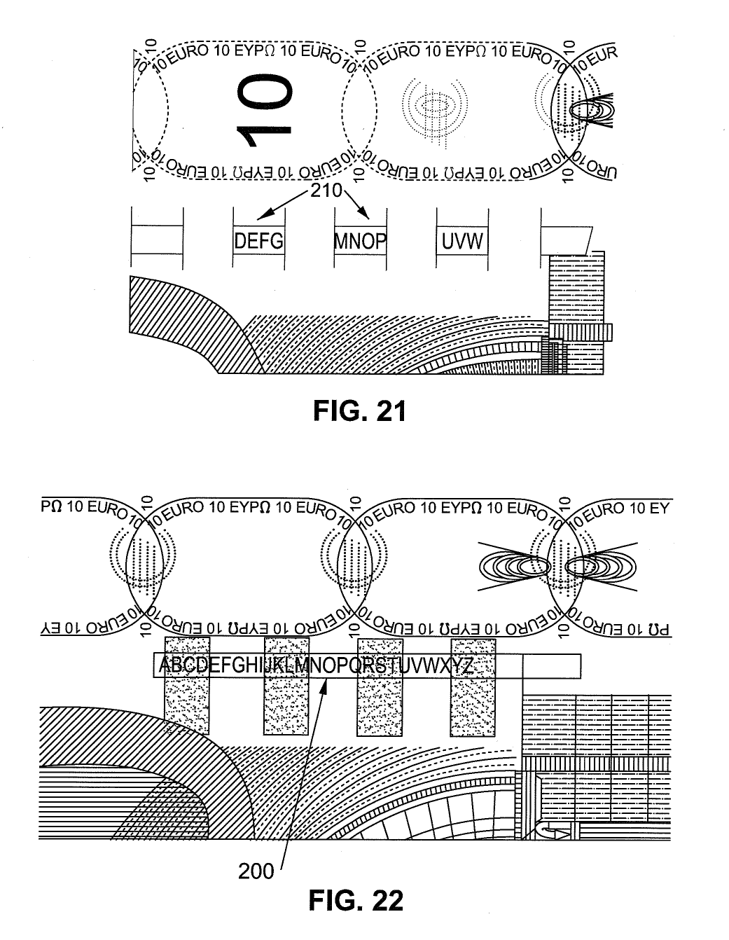

Resolution of the image using the flexographic printing process has shown to be as low as 20 microns although 70 microns is nominal. This is shown in FIG. 20. Besides text, a graphic image can be made by processing a scanned image using a FloydSteinburg technique as found in the software program COREL DRAW™. This program converts the image into square pixels, which have good black (image) and white (no image) contrast. After coating, the web is slit into ribbons between 1 and 5 mm wide wherein the text is generally situated in the center of the ribbon. FIG. 21 show the optically variable thread of this invention windowed into a bank note and FIG. 22 shows the text symbols when viewed in transmission.

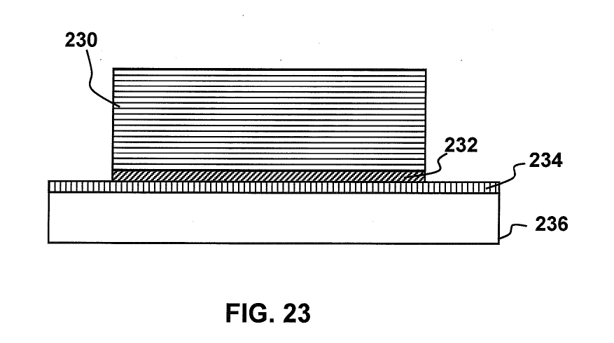

Instead of a ribbon, the device may function as a security stick-on label by applying adhesive 232 to one side of the PET and laminating to a release layer 234 supported by paper carrier 236 and die cutting the label 230 as is shown in FIG. 23. The adhesive can be a solvent based or a water-based adhesive. A suitable adhesive is an acrylic adhesive, among many others. Instead of a label, the product could be made into a hot-stamp security product by inserting a release layer between the carrier web and the vacuum deposited layer.

Of course numerous other embodiments may be envisaged without departing from the spirit and scope of the invention.

What is claimed is:

1. An OV device comprising:
a substrate, and
an optical stack supported by the substrate consisting of
a reflector layer, an absorber layer, and a dielectric layer between the reflector layer and the absorber layer;
wherein the reflector layer is a partially transparent layer.

2. An OV device as defined in claim 1, wherein the reflector layer a thickness below the opaque point.

3. An OV device as defined in claim 1, wherein the reflector layer is an aluminum layer having a thickness less than 20 nm.

4. An OV device as defined in claim 1, wherein the reflector layer is an aluminum layer having a thickness of 10 nm or less.

5. An OV device as defined in claim 1, wherein the substrate has an image thereon visible through the optical stack.

6. An OV device as defined in claim 5, wherein the image is printed using a regular or OV ink.

7. An OV device as defined in claim 5, wherein the image is a text printed onto the substrate and is readable through the optical stack.

8. An OV device as defined in claim 7, wherein the text is printed backwards so that in viewing the text though the substrate, the text is oriented normally.

9. An OV device as defined in claim 1, wherein the substrate is transparent and whereby a text can be read through the OV device.

10. An OV device as defined in claim 1, wherein the absorber layer is patterned so that the optical stack has partially transparent OV regions and partially transparent non-OV regions.

11. An OV device as defined in claim 1, wherein the dielectric layer is patterned so that the optical stack has partially transparent OV regions and partially transparent non-OV regions.
